(19) United States
(12) Patent Application Publication
(10) Pub. No.: US 2025/0021837 A1
(43) Pub. Date: Jan. 16, 2025

(54) AUTOMATIC MODEL ONBOARDING AND SEARCHING-BASED OPTIMIZATION

(71) Applicant: VISA INTERNATIONAL SERVICE ASSOCIATION, SAN FRANCISCO, CA (US)

(72) Inventors: Runxin He, Cedar Park, TX (US); Yu Gu, Austin, TX (US); Subir Roy, Austin, TX (US)

(73) Assignee: VISA INTERNATIONAL SERVICE ASSOCIATION, SAN FRANCISCO, CA (US)

(21) Appl. No.: 18/712,048

(22) PCT Filed: Nov. 23, 2021
(86) PCT No.: PCT/US2021/060648

§ 371 Date: May 21, 2024

(51) Int. Cl. G06N 5/04

(52) U.S. Cl. CPC G06N 5/04

(57) ABSTRACT

Embodiments of the present disclosure are directed to onboarding a model from a training platform to an inference platform and selecting parameters of the model to optimize performance of the model. For example, the onboarding of the model to the inference platform can be based on a series of interactions between a model onboarding systems at the training platform and at the inference platform. An optimization process can include a searching-based process to derive optimal settings for the model. The optimization process can simulate feature combinations of the model and identify an optimal combination of settings of the model for increased model performance.

### BACKGROUND

Machine learning models can be used for a wide range of applications. For example, a model can utilize deep learning techniques to process large volumes of data and derive various insights into the data. Based on the derived insights, various actions can be taken, such as to grant access to a resource or identify data for further processing, for example.

In many instances, prior to implementing a model into an environment with live data, the model can be trained on a training platform to create the model and to test various aspects of the model using training data and validation data. For instance, the model implemented in a training platform can process training data to derive an accuracy of the model in processing the training data. Further, the model can be modified at the training platform to increase accuracy in processing the training data. Testing the model can improve model accuracy prior to implementing the model at the environment with live data.

### SUMMARY

One embodiment of the present disclosure is directed to onboarding an optimized model from a training platform to an inference platform. The inference platform can obtain an onboarding request from a module of a training platform to migrate a model from the training platform to an inference platform. The onboarding request can be obtained after performance of a validation process by the training platform. The training platform can facilitate training of the model using one or more training datasets, and the inference platform can implement the model for processing obtained data.

The inference platform can download an application package comprising the model. Further, an optimization process can be performed for each of a set of settings for the model to optimize a data processing performance of the model by identifying a combination of the set of settings optimizing the data processing performance of the model. The optimization process can include iteratively selecting a configuration option for each setting based on a simulated data processing result for each configuration option. The model can be implemented at the inference platform with the identified combination of the set of settings.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

Reference to the remaining portions of the specification, including the drawings and claims, will realize other features and advantages of the present disclosure. Further features and advantages of the present disclosure, as well as the structure and operation of various embodiments of the present disclosure, are described in detail below with respect to the accompanying drawings. In the drawings, like reference numbers can indicate identical or functionally similar elements.

### BRIEF DESCRIPTION OF THE DRAWINGS

FIG. 1 illustrates a flow process for an example training platform according to an embodiment of the present disclosure.

FIG. 2 is a flow diagram of an example inference platform process according to an embodiment of the present disclosure.

FIG. 3 illustrates an example system comprising both a training platform and an inference platform according to an embodiment of the present disclosure.

FIG. 4 is an example flow process for generating optimized models for an inference platform according to an embodiment of the present disclosure.

FIG. 5 is a flow diagram for an example model optimization process according to an embodiment of the present disclosure.

FIG. 6 is a flow process for an example heuristic searching based optimization process according to an embodiment of the present disclosure.

FIG. 7 is a flow process of an example simulated annealing heuristic searching based optimization process according to an embodiment of the present disclosure.

FIG. 8 is an example flow diagram of an example simulated annealing heuristic searching-based optimization process according to an embodiment of the present disclosure.

FIG. 9 is an example flow process for onboarding an optimized model at an inference platform according to an embodiment of the present disclosure.

FIG. 10 shows a resource security system for authorizing access to resources according to an embodiment of the present disclosure.

FIG. 11 illustrates an example computer system according to an embodiment of the present disclosure.

### TERMS

Prior to discussing embodiments of the disclosure, description of some terms may be helpful in understanding embodiments of the disclosure.

The term “resource” generally refers to any asset that may be used or consumed. For example, the resource may be an electronic resource (e.g., stored data, received data, a computer account, a network-based account, an email inbox), a physical resource (e.g., a tangible object, a building, a safe, or a physical location), or other electronic communications between computers (e.g., a communication signal corresponding to an account for performing a transaction).

The term “access request” (also referred to as an “authentication request”) generally refers to a request to access a resource. The access request may be received from a requesting computer, a user device, or a resource computer, for example. The access request may include authentication information (also referred to as authorization information), such as a user name, resource identifier, or password. The access request may also include and access request parameters, such as an access request identifier, a resource identifier, a timestamp, a date, a device or computer identifier, a geo-location, or any other suitable information.

The term “access request result” generally refers to an outcome of an access request. The access request result may be received from a resource computer or an access server. The access request result may include all of the elements of the access request. For example, the access result may include authentication information (also referred to as authorization information), such as a user name, resource identifier, or password. The access request result may also include access request parameters, such as an access request identifier, a resource identifier, a timestamp, a date, a device or computer identifier, a geo-location, or any other suitable information. In addition, the access request result may include an evaluation score, or any suitable means of determination, for whether the access request was accepted (e.g., indicated by a positive evaluation score) or denied (e.g., indicated by a negative evaluation score). For example, if the access request result includes a positive evaluation score or determination, the user is granted access to the resource. Similarly, if the access result includes a negative evaluation score or determination, the resource computer denies access to the resource.

The term “model” generally refers to a machine learning model trained to process input data and identify certain types of patterns. A model can be trained over a set of training data, using a process to learn from the training data. As an example, a model can process an access request and make an assessment of whether the access request should be granted or denied access to a requested resource. The model can be trained on a training platform and migrated to an inference platform to process live data as described herein. “Model parameters” generally refer to variables of a model that are determined during training to allow the model to provide outputs for new samples, e.g., to provide access request results for new access requests.

The term “setting” generally refers to a configurable setting for the machine learning model. A given setting can include one or more configuration options (or “configuration values”) that can modify how a model is performed on a platform and that can affect a hardware performance of the model. Further, a combination of configuration options for a set of settings for a model can be identified (e.g., via an optimization process) that optimize the hardware performance of the model. Examples of settings for a model can include a maximum number of cached engines for the model, a minimum segment size for the model, a batch size during inference, a number of model instances for each device executing on the inference platform (e.g., a GPU, CPU), a number of machine learning operators and/or application layers running on different computing devices, etc.

The term “configuration option” generally refers to one of a set of values configured for a setting. The configuration option can specify a value (e.g., a bit size, a processing rate) used for the setting. As described in greater detail below, an optimization process can identify a configuration option for each setting that optimizes the hardware performance of the model.

The term “training platform” generally refers to a computing system facilitating training of a model. A training platform can obtain a model and provide a training dataset to the model. Based on the results in processing the training dataset, the model can be updated at the training platform. Further, the training platform can facilitate validation of a model prior to migrating a model to an inference platform.

The term “inference platform” generally refers to a computing system implementing a model. The inference platform can download a model and direct live data to the model for processing by the model. The inference platform can implement multiple models to process live data and process the results from the model(s) to determine whether to take an action (e.g., grant/deny access to a requested resource).

“Live data” can include a stream of access requests provided by another computing instance (e.g., a client computer) to be processed by the model. The model can process each access request as part of the live data and provide a response to each access request for use in determining whether to take an action, such as to provide access to a requested resource, for example.

The term “hardware performance characteristic” generally refers to a metric in performing data processing processes. Example hardware performance characteristics can include a throughput or latency in processing data. The hardware performance characteristics can be specific to computing resources for the inference platform.

The term “server computer” may include a powerful computer or cluster of computers. For example, the server computer can be a large mainframe, a minicomputer cluster, or a group of computers functioning as a unit. In one example, the server computer may be a database server coupled to a web server. The server computer may be coupled to a database and may include any hardware, software, other logic, or combination of the preceding for servicing the requests from one or more other computers. The term “computer system” may generally refer to a system including one or more server computers coupled to one or more databases.

### DETAILED DESCRIPTION

Various computing systems can implement one or more models to process streams of data and provide insights into the data. A model can implement Artificial Intelligence (AI) techniques or deep learning techniques to process input data stream(s) and identify anomalous data patterns or to determine whether to grant access to a resource. For instance, applications in a computing system can implement fraud detection or stand-in processing that leverage one or more deep learning models. In this example, such models may process time series data and may need to be frequently re-trained and/or updated to track the most recent data patterns.

In many instances, a new model can be introduced to the computing system. As a new model is introduced, the model can be tested on a training platform. The training platform can allow for training/testing of the model using training datasets to train the model and determine an accuracy in the model in deriving insights into the training dataset (e.g., determining whether to grant access to a resource).

After testing the model on the training platform, the model can be migrated to an inference platform to process live data. After migrating the model to the integration platform (e.g., by downloading a new model package), the model may not have optimal data processing characteristics (e.g., latency, throughput). This may be due to the testing of the model being done at the training platform using training data and training configurations/devices, not the live data and devices provided in the inference platform.

In many cases, onboarding AI models from a training platform to an inference platform can apply default model configuration settings, which may lead to unnecessary latency or errors in processing the data. Models migrated directly from a training platform may be not optimal for a corresponding inference platform, which can lead to inefficient use of computing resources at the computing system (e.g., a datacenter).

The present embodiments relate to onboarding a model from a training platform to an inference platform and selecting parameters of the model to optimize performance of the model. For example, the onboarding of the model to the inference platform can be based on a series of interactions between a model onboarding systems at the training platform and at the inference platform. An optimization process can include a searching-based process to derive optimal settings for the model. For example, a Simulated Annealing Heuristic Searching algorithm can be executed to simulate feature combinations of the model and identify an optimal combination of settings of the model for increased model performance.

As an illustrative example, an onboarding request can be obtained from a module at a training platform to migrate a model from the training module to an inference platform. The onboarding request can be obtained after performance of a validation process at the training platform. An application package that includes the model can be downloaded at the inference platform. A searching-based setting optimization process can further be performed for each of a set of settings relating to a data processing performance of the model to identify a combination of optimized settings optimizing the data processing performance of the model. The model can then be implemented at the inference platform with the combination of optimized settings.

### I. System for Generating Optimized Models on an Inference Platform

As described above, a training platform can allow for training and validation of a model. For instance, the model can process training data and derive an accuracy of the model. Particularly, the accuracy of the model can be based on a comparison of data identified by the model with known results for the training data.

### A. Training Platform

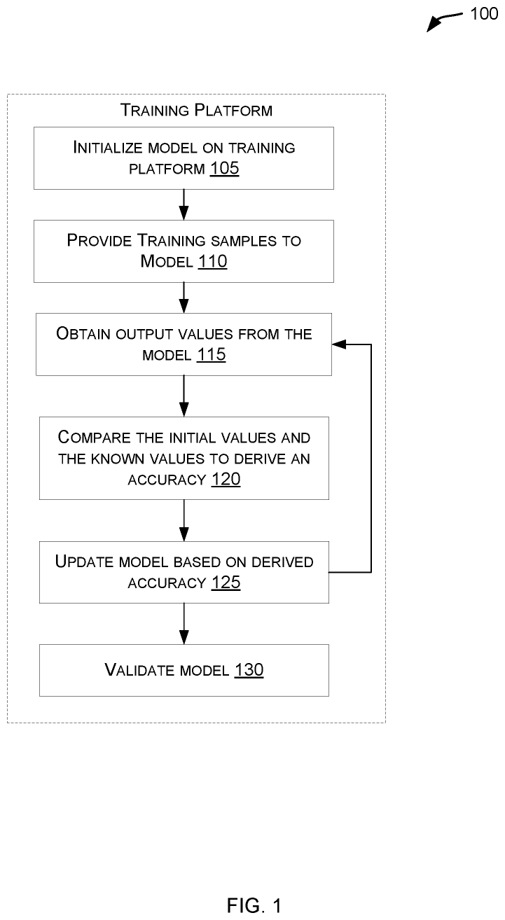

FIG. 1 illustrates a flow process for an example training platform 100. The training platform 100 can include a computing environment allowing for the training and validation of a model as described herein.

At 105, the model can be initialized. For example, the model can be downloaded at the training platform from a client device. The training platform can include an object storage capable of storing one or more models for training as described herein. In some instances, responsive to downloading the model, data (e.g., training dataset) can be directed to the model.

At 110, a training dataset can be provided to the model. The training dataset can include a dataset of known samples (e.g., access requests) to simulate live data samples. For example, the training dataset can provide a series of access requests requesting access to a credential (e.g., a secure data element). Further, a portion of the training dataset can include valid access requests (e.g., samples to be provided access to the credential), while another portion can include invalid access requests (e.g., samples to be denied access to the credential or elevated for further processing). Known values for the training dataset can also be provided to the training platform that are used to derive an accuracy of a model in processing the training dataset.

At 115, output values can be obtained from the model. The output values can specify portions of the training dataset identified as a result of processing the training dataset by the model. The output values can be derived by processing the model and classifying data portions in the training data. For example, the output values can provide an indication of all access requests in the training data identified as denied/invalid access requests.

At 120, the output values from the model can be compared with the known values for the training dataset to derive an intermediate accuracy of the model. The accuracy can quantify a difference between the identified output values and the known values for the training dataset. For example, an accuracy can increase with the number of matches between the identified output values and the known values for the training dataset. Further, the accuracy can also be indicative of any output values incorrectly identified by the model or any known values missed by the model. The accuracy can be defined using a cost/loss function that is optimized to determine the parameters. The accuracy can be used in deriving insights into improving the model, e.g., how the parameters can be changed to improve accuracy.

At 125, the model can be updated based on the derived accuracy. For example, one or more parameters relating to the performance of the model can be updated to improve the performance of the model. Example parameters include weights in a neural network or thresholds used in a decision tree.

Various machine learning models can be used, such as support vector machines, logistic regression, neural networks, and decision trees. Additionally, ensemble techniques (such as boosting or bagging) can use multiple model types or multiple models of a same type. Boosting can reduce bias and variance, and can convert weak learners to strong ones, e.g., increasing accuracy. Example boosting techniques include gradient boosting and adaptive boosting (Adaboost). Additionally, bagging algorithms can be used, such as random forest. Various solvers can be used for the training to determine the optimized solution, e.g., to update the model in block 125. Example solvers include gradient techniques, such as gradient descent, stochastic average gradient, or backpropagation, as well as other techniques of higher order such as conjugate gradient, Newton, quasi-Newton, or Levenberg-Marquardt.

At 130, a validation process can be performed to validate the model. For example, a validation dataset can be provided to the model for processing by the model, where the model may not have access to any known values for the validation dataset. An accuracy in processing the validation dataset can be derived that quantifies a difference between the identified output values and the known values for the validation dataset. In some instances, the model may be onboarded to the inference platform upon validating the model as described herein.

In some instances, the accuracy as described in FIG. 1 can be defined by a cost function. As examples, a cost function can include a sum of individual metrics, a difference between individual metrics, and/or a weighted average of the individual metrics.

### B. Inference Platform

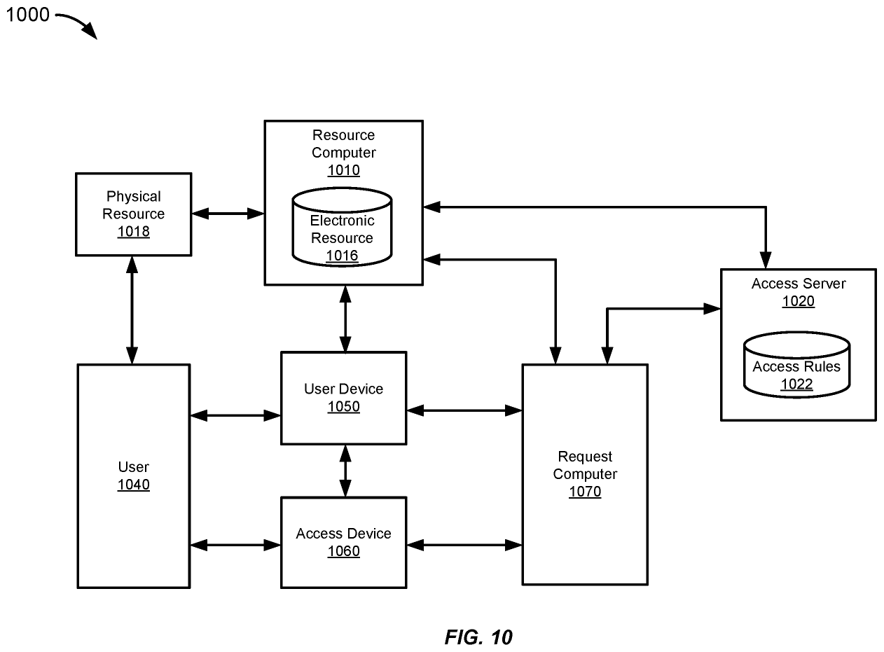

As described above, an inference platform can allow for live data processing. For example, an inference platform can forward a stream of access requests to a model for the model to determine whether to grant access to a resource. In some instances, access requests for a computer resource or account (e.g., transactions over the Internet) can go through a fraud detection system to determine whether the transaction is authorized or rejected as being fraudulent. Thus, a resource security system may receive requests to access a resource. An exemplary resource security system is described in further detail below at FIG. 10.

The access request can receive a statistically significant number of access requests for a plurality of resources. The statistically significant number of access requests can include a threshold number of access requests (e.g., at least 1,000, 5,000, 10,000, 50,000, 100,000, 5000,000, or 1,000,000). The model can determine responses to the statistically significant number of access requests and measure metrics (e.g., a hardware performance) of the model at the inference platform. Implementing one or more models at the inference platform can allow for efficient processing of large volumes of access requests with increased accuracy in determining whether to grant or deny access to a resource for each access request.

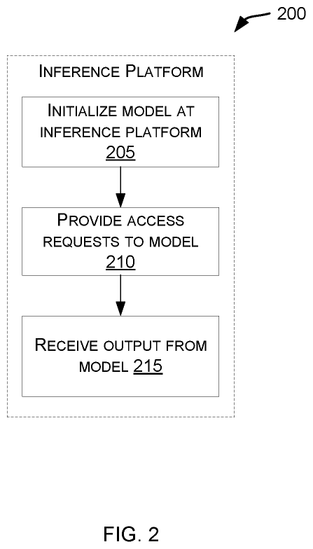

FIG. 2 is a flow diagram of an example inference platform process. The inference platform can be implemented on one or more computing instances and can access various data sources providing data (e.g., access requests) to the inference platform.

At 202, the model can be initialized at the inference platform. For example, a model can be downloaded as part of an application package. The model can be onboarded from a training platform to the inference platform using an onboarding process as described in greater detail below.

At 204, a stream of access requests can be provided to the model. Each access request can request access to a resource (e.g., a secure data element) and can include various features relating to the access request. Examples of such features can include a time of initiating the access request, an identifier for a user device initiating the access request, credentials, keys, etc.

As an example, an access request can specify a request to initiate a transaction at a resource provider device using a user device for a client. In this example, the access request can specify an identifier for the resource provider device, a transaction amount, a user device identifier (e.g., a primary account number (PAN)), an IP address for the resource provider device, etc.

At 206, the model can provide an output (e.g., an access request result) for each access request. The output from the model can provide an assessment (e.g., a risk assessment) of whether access to the resource should be granted or denied. In some instances, the output from the model can be passed to another computer for making a final determination of whether to grant access to the resource.

For example, if the model provides an output specifying a recommendation to grant access to a resource, the inference platform can generate an authorization request message using data from the access request and the resource and pass the authorization request message to a corresponding authorizing entity. As another example, if the model provides an output recommending denial of access to the resource, the inference model can flag the access request for further processing or provide a notification to a resource provider indicating that the access request has been denied.

The model can incorporate various deep learning techniques to provide an output specifying an assessment recommending whether to grant or deny access to a resource. For example, a model can utilize deep learning techniques to generate an output by processing multiple features of an access request. For instance, if the access request providing a specific user device identifier that is invalid (e.g., the access devices provides an expired credential), the access request may be denied.

### C. Onboarding and Optimizing Settings for a Model

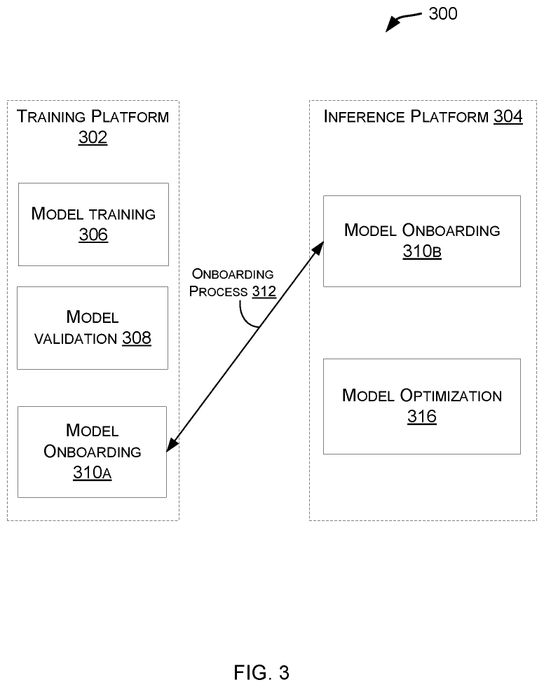

As noted above, a model can be trained and validated at a training platform using training datasets. Further, the model can be migrated from the training platform to an inference platform via an onboarding process. Once onboarded to the inference platform, the model can be processed to derive configuration values for each setting of a set of settings of the model that optimizes a hardware performance characteristics for the mode at the inference platform. FIG. 3 illustrates an example system 300 comprising both a training platform 302 and an inference platform 304.

The training platform 302 can facilitate model training 306, model validation 308, and model onboarding 310. The model training 306 can include processing the model with one or more training datasets to increase an accuracy in determining whether to grant/deny access to a resource, for example.

The model validation 308 can include providing a dataset with known results to the model for the model to process the dataset (e.g., to determine whether each access request in the dataset is to be granted/denied access to a requested resource. The output values for the dataset (e.g., an indication of whether each access request is granted/denied access to the requested resource) can be compared with the known results for the dataset to determine a similarity between the output values and the known results. If the output values exceed a threshold similarity to the known results for the dataset, the model can be validated.

The training platform 302 and the inference platform 304 can perform model onboarding 310A-B by performing an onboarding process 312. The onboarding process 312 can include a series of steps to migrate the model from the training platform 302 to the inference platform 304.

For example, the onboarding process 312 can include the training platform parsing model information and generating an update patch package for the inference platform. The parsed model information can include any of a model version, a model name, model features, default model values, etc. The model information can be in various formats, such as a JavaScript Object Notation (JSON) or YAML format, for example. The model and model information can be stored at the training platform (e.g., in a web store or repository) along with a uniform resource locator (URL) for downloading the model.

The inference platform 304 can obtain a request to provision the model during the onboarding process 312. For example, responsive to receiving the request, the inference platform 304 can download a new model package that contains the model. The inference platform 304 can implement the model for processing access requests obtained by the inference platform 304.

The inference platform can further perform model optimization by identifying a combination of model parameters that optimize hardware performance characteristics (e.g., a data processing latency, throughput) for the model. For instance, a searching-based heuristic process can be implemented to derive a combination of configuration options for settings of the model that optimize the hardware performance characteristics for the model. Optimizing the hardware performance characteristics for a model can increase model efficiency in processing volumes of data (e.g., access requests) obtained at the inference platform 304.

### D. Flow Process for Generating Optimized Models for an Inference Platform

As described above, the model can be implemented at a training platform for training, onboarded to an inference platform, and optimized for the inference platform by deriving a combination of optimized model parameters. The optimized model parameters can be derived using a searching-based technique to identify a combination of parameters having a greatest data processing efficiency of the model at the inference platform.

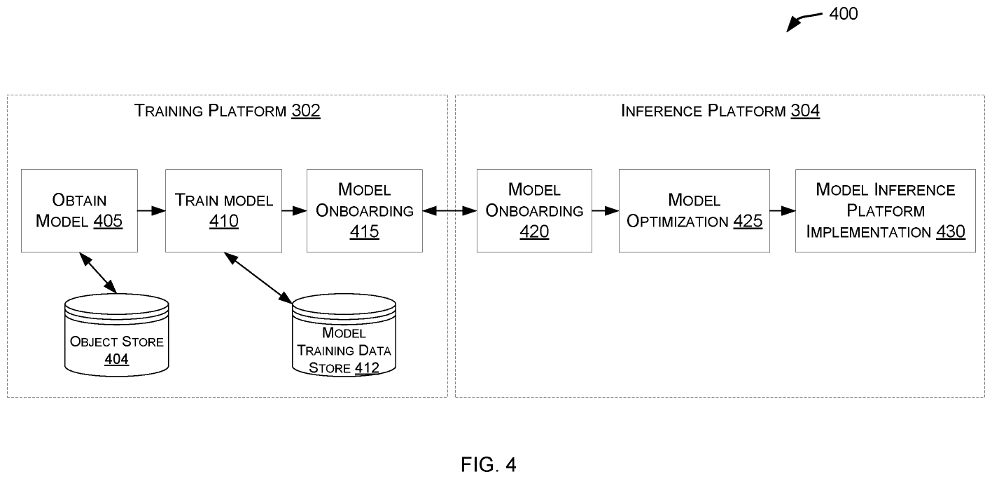

FIG. 4 is an example flow process 400 for generating optimized models for an inference platform.

At 405, the model can be obtained. For example, a model can be downloaded via a URL from a client device. The model (and corresponding model information) can be stored at an object store 404.

At 410, the model can be trained. For example, a training dataset can be obtained from model training data store 412 and provided to the model for training. As discussed above, training the model can include comparing output values from the model with known values for the training dataset. Further, parameters of the model can be updated based on the accuracy of the model to increase an accuracy of the model in identifying output values that correspond with the known values for the training dataset.

At 415, the model can be onboarded to the inference platform using an onboarding process. For example, the training platform can parse information from the model and register the model information at a Consul. The model and a URL for download can be stored in object store 404.

At 420, the inference platform can communicate with the training platform to perform the onboarding process. The inference platform can perform a one-time registration with a controller at the training platform during an initialization process. The inference platform can monitor for an update to the controller, parse the model information, and download the model at the inference platform. The onboarding process can include generating an application package including the model. The communications between the inference platform and training platform can be encrypted using a key shared between the inference platform and training platform. For example, the inference platform can decrypt a URL providing an application package using a key shared between the inference platform and training platform.

In some instances, the inference platform may download an application package from a training platform responsive to determining that a network identifier for the training platform is included in a whitelist for the inference platform. Whitelists can be created by the inference platform recording internet protocol (IP) and/or media access control (MAC) addresses for the training platform. If a new model is provided from an unidentified source, an alert can be initiated to verify the source and/or add the unidentified source to the whitelist. A dynamic token system can be introduced for the communication between the training platform, inference platform, and/or a client device. If the password and key are not matched in communications between the training platform, inference platform, and/or the client device, an alert can be triggered.

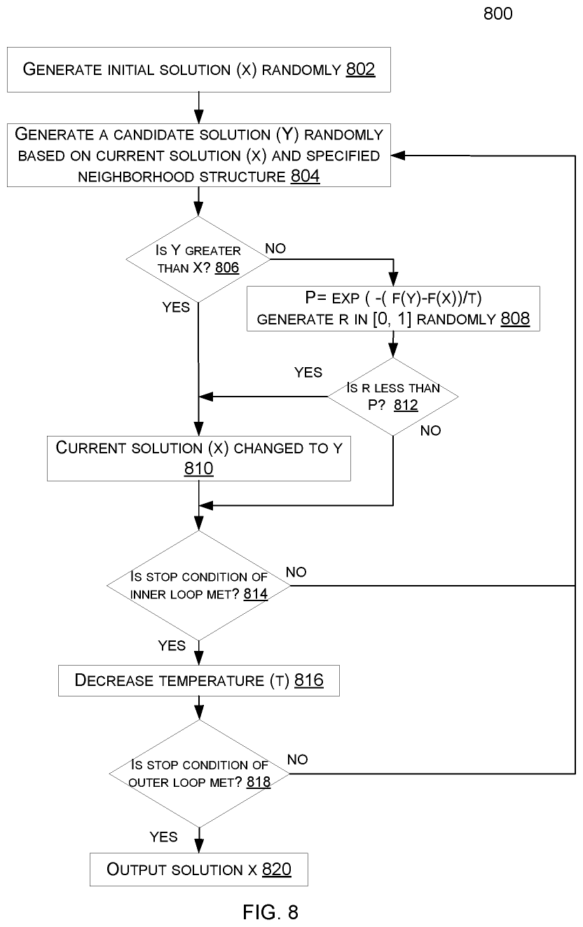

At 425, the model can be optimized at the inference platform. Optimizing the model can include identifying a combination of settings for the model that optimize data processing parameters (e.g., latency, throughput) at the inference platform. For example, as described in FIG. 8 below, a heuristic searching-based optimization process can be performed to identify a combination of parameters to be implemented at the inference platform to optimize the data processing parameters at the inference platform. Model optimization at the inference platform is described in greater detail below.

For example, settings for various tools for the model can be optimized, such as an open-source deep learning compiler framework for one or more computing devices (e.g., a field programmable gate array (FPGA) or a CPU). The tools can re-compile the model and optimize neural layers by one or more optimization algorithms, such as vectorization, loop permutation, array packing, etc. Examples of optimization algorithms are further discussed in

“Deep compression: compressing deep neural networks with pruning, trained quantization and Huffman coding,” by Han, Song, Huizi Mao, and William J. Dally (ICRL (2016)) and “Grow and prune compact, fast, and accurate LSTMs” by Dai, Xiaoliang, Hongxu Yin, and Niraj K. Jha (IEEE Transactions on Computers 69.3 (2019): 441-452).

At 430, the model can be implemented at the inference platform. For instance, the model can be updated to incorporate the combination of configuration options for a set of settings as derived above. The inference platform can direct live data (e.g., comprising a stream of access requests) to the model for the model to process the live data and provide responses to the access request. In response, the inference platform can facilitate granting/denying access to requested resources based on the responses provided by the model.

### II. Model Optimization at an Inference Platform

### A. Optimizing a Model

As described above, a model can be optimized at the inference platform. For example, a combination of configuration options for settings of a model can be identified that optimize hardware performance characteristics in the model processing data at the inference platform. As an example, inference platform configuration settings for a model can relate to a graphical processing unit (GPU) or a library for the GPU. Examples of the configuration settings can relate to a precision used for optimization, a maximum number of cached engines, a minimum segment size, etc.

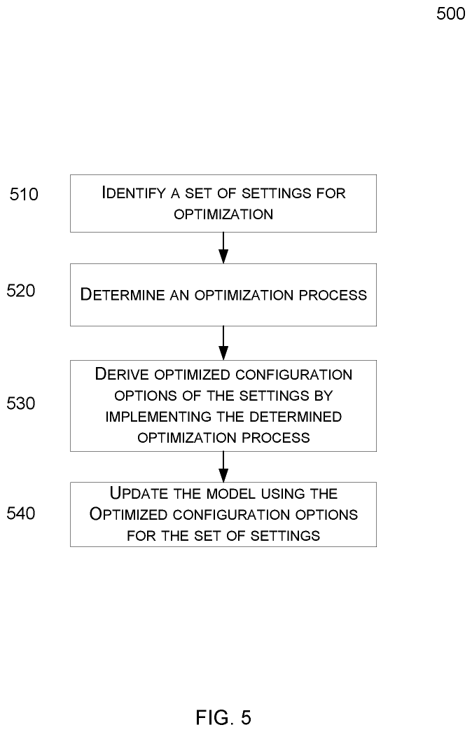

FIG. 5 is a flow diagram for an example model optimization process. The model optimization process can derive a configuration option (or configuration value) for each setting of the model that optimizes a hardware performance of the model at the inference platform.

At 510, a set of settings, for optimization can be identified. For example, for a model, each of the set of settings can include settings of a model that, if modified, can impact hardware performance characteristics of the model. Example settings can include the number of instances running in each GPU or CPU, the batch size for each machine learning model instance, the layers of the model running in a different GPU or CPU, the inference accuracy for different operators, etc. As an illustrative example, a setting can include a maximum number of cached engines used for the model that impact a throughput in processing access requests at the inference platform. Increasing the number of cached engines can enable more throughputs at the same time, but may require more computation resources (e.g., more GPU or CPU cores and data bandwidth) which may influence other services or go beyond the computational resource limitations. The settings for a model can differ based on a type of model. Further, each setting can include multiple configuration options (e.g., multiple cached engine values for a setting comprising a maximum number of cached engines).

At 520, an optimization process can be identified. Examples of an optimization process can include a heuristic searching-based optimization process or a simulated annealing optimization process. The optimization process can be selected as part of a configuration process or automatically selected based on a number of settings for the model. For example, if the model comprises a number of settings that exceed a threshold number, the optimization process can be selected to include a simulated annealing heuristic searching-based optimization process as such a process can more efficiently select optimized settings in complex models.

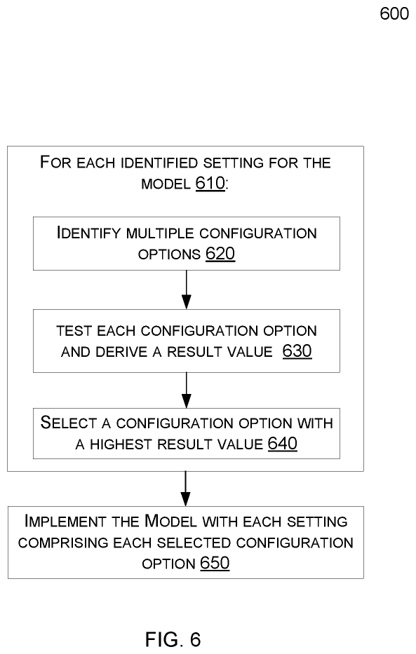

At 530, optimized configuration options for each setting can be determined by implementing the determined optimization process. For example, a searching-based optimization process as described in FIG. 6 below can be implemented for each of the set of settings identified in 510 to identify a combination of configuration options for the set of settings can be identified for the model.

At 540, the model can be updated using the combination of configuration options for each of the set of settings. The settings can be modified using corresponding configuration options identified in 530 to increase hardware performance characteristics at the inference platform.

### B. Searching-Based Optimization

As described above, an example optimization process can include a heuristic searching based optimization process. The heuristic searching based optimization process can include identifying all configuration options for each setting and can testing each configuration option to derive a simulated result (e.g., throughput, latency). The simulated result for each option can be used to select an option for each setting to derive the optimized settings.

FIG. 6 is a flow process 600 for an example heuristic searching based optimization process.

A heuristic searching-based optimization process can include testing each configuration option for a setting to select configuration options for each setting that optimize hardware performance characteristics for a model. As an example, for a given set of configuration options (e.g., values) for each settings, the model can be tested at the inference platform to determine one or more performance metrics, which can be combined into a single overall metric. For instance, the model can be run for a time duration (e.g., a few hours) on a number of transactions (e.g., 100,000 transactions). For each of these transactions, the latency and throughout in processing each transaction can be measured. A throughput can be measured over time as opposed to each transaction, e.g., number of transactions processed per minute. Further, an average of the measured metrics (e.g., latency, throughput) can be taken.

Then, one or more configuration options for one or more settings can be changed, and the model can be run again and a new performance can be measured. If the determined performance metric improves, new configuration option(s) can be accepted. If the determined performance metric does not improve, the new configuration option(s) can be rejected and a different change to configuration option(s) can be made.

At 610, the process can be performed for each identified setting for the model. Thus, blocks 620-640 can be performed for each identified setting. For example, after selecting a configuration option for a first setting, the process as described below can be repeated for each other identified setting to select configuration options for each setting of the model.

At 620, for each setting identified in 610, a number of configuration options can be identified. As an example, a number of configuration options (e.g., varying bit size values) can be identified for a setting comprising a minimum bit size setting for the model.

At 630, for each identified setting, each configuration option can be tested to derive a result for the configuration option. For instance, for a configuration option identified in 620 for a setting, the model can be tested using a combination of configuration options including the configuration option for the setting. In performing the test, a result can generated quantifying hardware performance characteristics for a specified configuration option.

The result can quantify one or more performance metrics, such as a latency or throughput in processing a volume of data for a time duration, for example. This process can be repeated for each configuration option for a setting, providing results that can be compared specifying different hardware performance characteristics for each configuration option.

At 640, for each identified setting, a configuration option can be selected for each setting. For instance, the configuration option can be based on a defined metric score, which can include a combination of the inference throughput and latency and total workload of the inference platform. As noted at 630 above, result quantifying performance metrics (e.g., hardware performance characteristics) can be derived for each configuration option. The results for each configuration option can be compared to select a configuration option for a setting. For example, a configuration option with results quantifying a greatest throughput in processing data at the inference platform can be selected for the setting. Selecting a configuration option as described herein can optimize hardware performance characteristics of the model at the inference platform. The process as described herein can be performed for each identified setting for the model.

At 650, the model can be implemented with each set of settings comprising a corresponding selected configuration option. The set of settings with selected configuration options can comprise settings that optimize data processing performance of the model at the inference platform.

### C. Iterative Heuristic Searching-Based Optimization

As described above, an example optimization process can include a heuristic searching based optimization process. This process can include iteratively deriving a result for each configuration option for a setting and update a stored value for the setting if the result exceeds that of the stored value. In some instances, performing a heuristic searching-based optimization process can provide a more efficient optimization process for models with multiple settings.

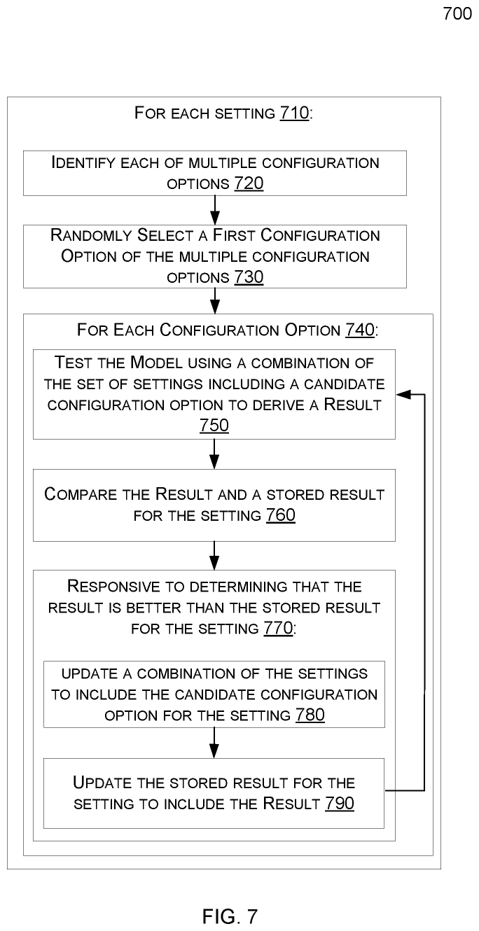

FIG. 7 is a flow process 700 of an example iterative heuristic searching-based optimization process. The iterative heuristic searching-based optimization process can iteratively process combinations of settings of the model to derive configuration options (e.g., or configuration values) that optimize hardware performance of the model at the inference platform.

At 710, the optimization process can be performed iteratively for each identified setting for the model. For example, responsive to processing each configuration option for a first setting and selecting a configuration option for the first setting as described below, the process as can be repeated for a second setting. This can be repeated for each identified setting for the model.

At 720, a number of configuration options for each setting of the model can be identified. As described above, each setting for the model can have a number of potential configuration values (e.g., configuration options) that can impact hardware performance characteristics of the model. In addition to examples described elsewhere in this disclosure, example configuration options can also include a gpu_execution_accelerator (e.g., providing a name of “tensorrt,” parameters providing a key of a “precision_mode,” a value of “FP16”), where the inference accuracy can be set from an original double float value into float 16 bit value, which can decrease the inference accuracy level but accelerate processing speed.

At 730, a first configuration option of multiple configuration options for a setting can be selected, e.g., randomly. In some instances, a stored result for the setting can be updated to include the first configuration option. As described in greater detail below, the stored result is compared with a result for a candidate configuration option to determine whether to update the setting to include the candidate configuration option.

At 740, each configuration option for a setting can be iteratively processed as a candidate configuration option. For example, after processing a first configuration option as a candidate configuration option, the process can be repeated for each other identified configuration option (e.g., as identified in 720) to derive a configuration option for the setting that optimizes the hardware performance of the inference platform.

At 750, the model can be tested using a combination of the set of settings including a candidate configuration option for a corresponding setting to derive a result (e.g., a transactions per second (TPS) and latency result). The derived result can quantify hardware performance characteristics in processing data at the inference platform for the combination of settings including a setting configured with the candidate configuration option.

At 760, the result for the candidate configuration option can be compared with a stored result for the setting to determine whether the result is better or worse than the stored result for the setting. For example, the TPS and latency result for a candidate configuration option can specify that a throughput in processing data is greater than or less than a throughput specified in a stored result (e.g., for a previously-stored configuration option) for the setting. The stored result can include a either default result or a result for another configuration option for a setting.

At 770, it can be determined whether the result for the candidate configuration option exceeds the stored result for the setting. For example, a TPS and latency result exceeding the stored result for the setting can indicate that a candidate configuration option comprises greater hardware performance characteristics than that of a previously-stored configuration option for the setting. Alternatively, a TPS and latency result lower than the stored result for the setting can indicate that a candidate configuration option comprises lower hardware performance characteristics (e.g., a lower throughput in processing data) than that of the previously-stored configuration option for the setting.

At 780, responsive to determining that the result for the candidate configuration option is better than the stored result for the setting, the combination of the settings can be updated to include the candidate configuration option for the setting. This process can be repeated for each configuration option for a setting to identify a best combination of configuration options with the best hardware performance for the inference platform.

At 790, responsive to determining that the result for the configuration option is better than the stored result for the setting, the stored result for the setting can be updated to include the result. This process can be iteratively updated for each configuration setting such that only configuration options that exceed a previous result are stored for that setting. After updating the stored result for the setting, another combination of configuration options that includes a second configuration option for a setting can be processed at 750. In some instances, a number of configuration values for one or more settings can be tested as described herein.

### D. Simulated Annealing Heuristic Searching-Based Optimization

As noted above, simulated annealing heuristic searching-based optimization can iteratively identify optimized configuration options for each setting. For example, a simulated annealing heuristic searching-based optimization process can include starting with a random setting. The simulated annealing heuristic searching-based optimization process can use a result (e.g., a TPS and latency result) for a configuration option to find a global minimum and avoid a local minimum. The simulated annealing heuristic searching-based optimization process can process a model more efficiently than in other optimization processes in models comprising a greater number of configurable settings.

A loop can be initiated with the random setting based on a current setting and a Gaussian probability density function (PDF). For instance, a TPS and latency result can be calculated based on a new setting. If the new setting has a better performance than a current setting, the current setting is replaced by the new setting. If the new setting has a lower performance than a current setting, the current setting may be replaced according to a probability. However, if the new setting fails, the previous candidate setting can be kept. The loop can end when the iteration reaches an end or if a performance metric reaches a threshold level. The last setting can be applied as part of the set of settings for the model.

In some instances, the performance can be defined by a cost function that is optimized using an optimization process to determine optimal input settings, e.g., as described herein. The cost function can be defined prior to optimization. As examples, a cost function can include a sum of individual metrics (e.g., in a metric score), a difference between individual metrics, and/or a weighted average of the individual metrics. A current cost value of a cost function can be evaluated using this comparison to iteratively determine how a configuration value is to be updated. Such a cost function can be utilized in an optimization process as described in FIGS. 6 and 7, as well as in the example technique in FIG. 8.

FIG. 8 is an example flow diagram 800 of an example simulated annealing heuristic searching-based optimization process. At 802, an initial solution (x) can be generated randomly. For example, the initial solution can include a selection of a configuration option for each setting randomly.

At 804, a candidate solution (y) can be generated randomly based on a current solution (x) and specified neighborhood structure. The candidate solution can include modifying a configuration option for a first setting.

At 806, a determination can be made whether the candidate solution (y) is better than the initial solution (x). For example, the candidate solution (y) and the initial solution (x) can include the configuration values of a setting. The candidate solution (y) can be better than the initial solution (x) if F (Y) is less than F (X). The function (F) can include a measure of the performance given a current configuration value.

At 808, responsive to the candidate solution (y) being less than initial solution (x), a probability value (P) for a probability function can be derived. The probability function can comprise an exponent of a function of the candidate solution and the initial solution divided by a temperature. Further, a random value (r) between 0 and 1 can be derived randomly.

At 810, if the candidate solution (y) is greater than the initial solution (x), the current solution (x) can be changed to the candidate solution (y). This can iteratively update the current solution for each configuration option for a model.

At 812, a determination is made whether the random value (r) is less than the probability value (P) derived from the probability function. If the random value (r) is less than the probability value (P) derived from the probability function, the current solution (x) can be changed to the candidate solution (y) as described in 810. If the random value (r) is greater than the probability value (P), the current solution (x) remains the same.

At 814, it can be determined whether a stop condition of inner loop is met. This can include determining whether all configuration options for a setting have been tested. Responsive to the stop condition being met, the processing for another setting can be initiated.

At 816, responsive to determining that the stop condition for the inner loop is met, the temperature value (t) can be decreased. The temperature value (t) can modify the probability value derived from the probability function in 808.

At 818, it can be determined whether a stop condition of an outer loop is met. This can include determining whether all configuration options for all settings have been tested. Responsive to the stop condition being met, the combination of parameters for all settings can be implemented at the model as optimized settings.

At 820, the solution can be outputted. For example, the solution can include the set of settings optimized for data processing performance at the inference platform. The set of settings can be implemented at the model to optimize data processing (e.g., to increase latency, throughput) in processing live data (e.g., access requests).

### III. Flow Process for Onboarding and Optimizing a Model

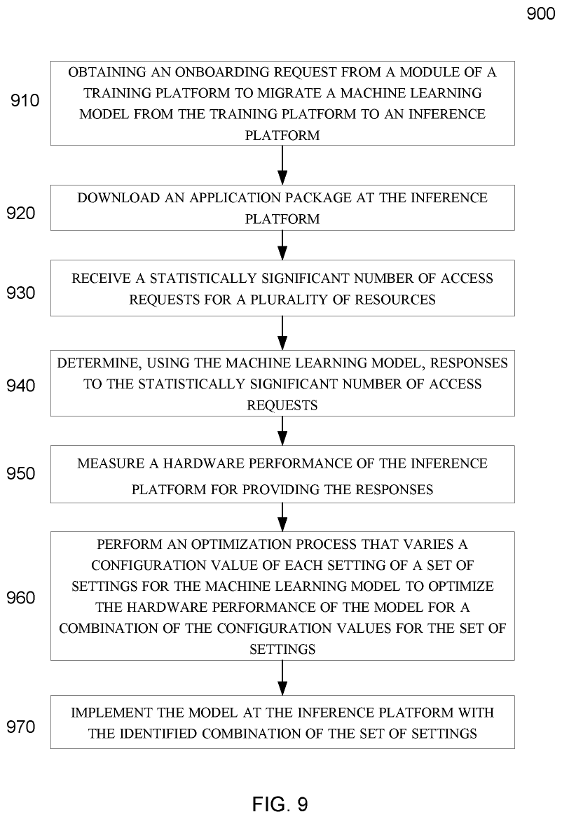

As described above the present embodiments relate to onboarding an optimizing a model at an inference platform. FIG. 9 is an example flow process 900 for onboarding an optimized model at an inference platform.

At 910, the process can include obtaining an onboarding request from a module of a training platform to migrate a model from the training platform to an inference platform. The training platform can facilitate training of the model using one or more training datasets. For example, the model can process a training dataset to derive an accuracy in the model to identify portions of data in the training dataset. Further, the model can be modified at the training platform to increase accuracy in identifying portions of data in subsequent datasets. The training platform can store the model and a uniform resource locator (URL) for the application package at a data repository.

The inference platform can be configured to implement the model for processing obtained data. For example, live data (e.g., access requests) can be provided to the model at the inference platform for the model to efficiently process the data (e.g., to determine whether to grant access to a resource for each access request).

The onboarding request can be obtained after performance of a validation process by the training platform. The validation process can include the model processing a training dataset and determining an accuracy of the model in identifying portions of data exceeding a threshold accuracy value.

In some instances, performance of the validation process at the training platform can include providing, to the model at the training platform, a training dataset for the model to derive a set of output data. Further, the set of output data can be compared with known results for the training dataset to derive an accuracy value based on a similarity between the set of output data and the known results, The model can be validated responsive to the accuracy value exceeding a threshold value.

At 920, an application package can be downloaded at the inference platform. The application package can comprise the model. The application package can be provided to the inference platform as part of an onboarding process between the training platform and inference platform. In some instances, the application package is downloaded at the inference platform responsive to the inference platform determining that the network address is included in a whitelist. The application package can be encrypted using a key common between the training platform and the inference platform. Further, the inference platform can decrypt the application package using the key.

At 930, a statistically significant number of access requests for a plurality of resources can be received. The statistically significant number of access requests can include a threshold number of access requests (e.g., at least 1,000, 5,000, 10,000, 50,000, 100,000, 5000,000, or 1,000,000). The model can determine responses to the statistically significant number of access requests and measure metrics (e.g., a hardware performance) of the model at the inference platform.

At 940, it can be determined, using the model, responses to the statistically significant number of access requests. The responses can specify an assessment of whether to grant access to specified resources. In response, the inference platform can pass the responses to another entity, such as resource security system, to make a determination of whether to grant access to the specified resources for the access requests.

At 950, a hardware performance of the inference platform for providing the responses can be measured. For example, the hardware performance can specify a data processing performance in the model processing the statistically significant number of access requests.

At 960, an optimization process can be performed that varies a configuration value of each setting of a set of settings for the machine learning model to optimize the hardware performance of the model for a combination of the configuration values for the set of settings. The optimization process can iteratively select the configuration value for each setting.

At 970, the model can be implemented at the inference platform with the identified combination of the set of settings. For example, a combination of set of settings can include string operators in a first layer (e.g., a tokenizing process) assigned to CPUs, and matrix operators in rest layers (e.g., add or multiplication layers) assigned to GPUs. Further, a series of access requests requesting access to a resource can be forwarded to the model. The model can provide, for each access request, a determination of whether to grant access to the resource or deny access to the resource. Based on the determination by the model, access to a resource (e.g., a secure data element) can be provided to a specified entity (e.g., an authorizing entity as part of an authorization request message).

### IV. Authentication for Accessing a Protected Resource

As described above, a model can process an access request to provide an assessment of whether to grant access to a resource. The assessment can be provided to a resource security system to authorize access to a secure resource.

FIG. 10 shows a resource security system 1000 for authorizing access to resources, in accordance with some embodiments. The resource security system 1000 may be used to provide authorized users (e.g., via authentication) access to a resource while denying access to unauthorized users. In addition, the resource security system 1000 may be used to deny fraudulent access requests that appear to be legitimate access requests of authorized users.

The resource security system 1000 may implement access rules to identify fraudulent access requests based on parameters of the access request. Such parameter may correspond to fields (nodes) of a data structure that is used to distinguish fraudulent access requests from authentic access requests.

The resource security system 1000 includes a resource computer 1010. The resource computer 1010 may control access to a physical resource 1018, such as a building or a lockbox, or an electronic resource 1016, such as a local computer account, digital files or documents, a network database, an email inbox, a payment account, or a website login. In some embodiments, the resource computer may be a webserver, an email server, or a server of an account issuer. The resource computer 1010 may receive an access request from a user 1040 via a user device 1050 (e.g., a computer or a mobile phone) of the user 1040. The resource computer 1010 may also receive the access request from the user 1040 via a request computer 1070 coupled with an access device 1060 (e.g., a keypad or a terminal). In some embodiments, the request computer 1070 may be a resource provider. For example, the request computer 1070 and the resource computer 1010 may be the same, wherein the access request from the user 1040 is generated directly at the resource computer 1010.

The access device 1060 and the user device 1050 may include a user input interface such as a keypad, a keyboard, a finger print reader, a retina scanner, any other type of biometric reader, a magnetic stripe reader, a chip card reader, a radio frequency identification reader, or a wireless or contactless communication interface, for example. The user 1040 may input authentication information into the access device 1060 or the user device 1050 to access the resource. Authentication information may also be provided by the access device 1060 and/or the user device 1050. The authentication information may include, for example, one or more data elements of a user name, an account number, a token, a password, a personal identification number, a signature, a digital certificate, an email address, a phone number, a physical address, and a network address. The data elements may be labeled as corresponding to a particular field, e.g., that a particular data element is an email address. In response to receiving authentication information input by the user 1040, the user device 1050 or the request computer 1070 may send an access request, including authentication information, to the resource computer 1010 along with one or more parameters of the access request.

In one example, the user 1040 may enter one or more of an account number, a personal identification number, and password into the access device 1060, to request access to a physical resource (e.g., to open a locked security door in order to access a building or a lockbox) and the request computer 1070 may generate and send an access request to the resource computer 1010 to request access to the resource. In another example, the user 1040 may operate the user device 1050 to request that the resource computer 1010 provide access to the electronic resource 1016 (e.g., a website or a file) that is hosted by the resource computer 1010. In another example, the user device 1050 may send an access request (e.g., an email) to the resource computer 1010 (e.g., an email server) in order to provide data to the electronic resource 1016 (e.g., deliver the email to an inbox). In another example, the user 1040 may provide an account number and/or a personal identification number to an access device 1060 in order to request access to a resource (e.g., a payment account) for conducting a transaction.

In some embodiments, the resource computer 1010 may verify the authentication information of the access request based on information stored at the request computer 1070. In other embodiments, the request computer 1070 may verify the authentication information of the access request based on information stored at the resource computer 1010.

The resource computer 1010 may receive the request substantially in real-time (e.g., account for delays computer processing and electronic communication). The term “real-time” may refer to computing operations or processes that are completed within a certain time constraint. The time constraint may be 1 second, 1 minute, 1 hour, 1 day, or 7 days. Once the access request is received, the resource computer 1010 may determine parameters of the access request. In some embodiments, the parameters may be provided by the user device 1050 or the request computer 1070. For example, the parameters may include one or more of: a time that the access request was received, a day of the week that the access request was received, the source-location of the access request, the amount of resources requested, an identifier of the resource being request, an identifier of the user 1040, the access device 1060, the user device 1050, the request computer 1070, a location of the user 1040, the access device 1060, the user device 1050, the request computer 1070, an indication of when, where, or how the access request is received by the resource computer 1010, an indication of when, where, or how the access request is sent by the user 1040 or the user device 1050, an indication of the requested use of the electronic resource 1016 or the physical resource 1018, and an indication of the type, status, amount, or form of the resource being requested. In other embodiments, the request computer 1070 or the access server 1020 may determine the parameters of the access request.

The resource computer 1010 or the request computer 1070 may send the parameters of the access request to the access server 1020 in order to determine whether the access request is fraudulent. The access server 1020 may store one or more access rules 1022 for identifying a fraudulent access request. Each of the access rules 1022 may include one or more conditions corresponding to one or more parameters of the access request. The access server 1020 may determine an access request outcome indicating whether the access request should be accepted (e.g., access to the resource granted), rejected (e.g., access to the resource denied), or reviewed by comparing the access rules 1022 to the parameters of the access request as further described below. In some embodiments, instead of determining an access request outcome, the access server 1020 may determine an evaluation score based on outcomes of the access rules. The evaluation score may indicate the risk or likelihood of the access require being fraudulent. If the evaluation score indicates that the access request is likely to be fraudulent, then the access server 1020 may reject the access request.

The access server 1020 may send the indication of the access request outcome to the resource computer 1010 (e.g., accept, reject, review, accept and review, or reject and review). In some embodiments, the access server 1020 may send the evaluation score to the resource computer 1010 instead. The resource computer 1010 may then grant or deny access to the resource based on the indication of the access request outcome or based on the evaluation score. The resource computer 1010 may also initiate a review process for the access request.

In some embodiments, the access server 1020 may be remotely accessed by an administrator for configuration. The access server 1020 may store data in a secure environment and implement user privileges and user role management for accessing different types of stored data. For example, user privileges may be set to enable users to perform one or more of the following operations: view logs of received access request, view logs of access request outcomes, enable or disable the execution of the access rules 1022, update or modify the access rules 1022, change certain access request outcomes. Different privileges may be set for different users.

The resource computer 1010 may store access request information for each access requests that it receives. The access request information may include authentication information and/or the parameters of each of the access requests. The access request information may also include an indication of the access request outcome for the access request, e.g., whether access request was actually fraudulent or not. The resource computer 1010 may also store validity information corresponding to each access request. The validity information for an access request may be initially based on its access request outcome. The validity information may be updated based on whether the access request is reported to be fraudulent. In some embodiments, the access server 1020 or the request computer 1070 may store the access request information and the validity information.

### IV. Computer System Overview

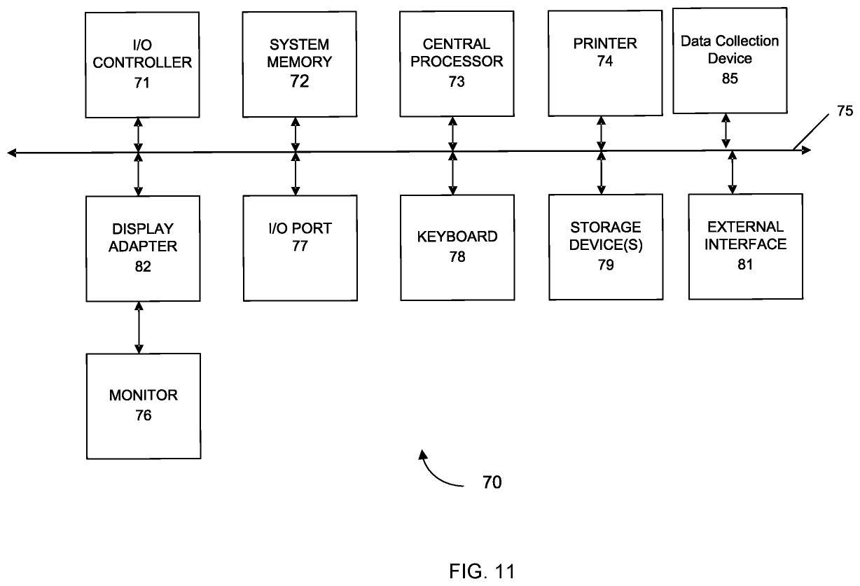

Any of the computer systems mentioned herein may utilize any suitable number of subsystems. Examples of such subsystems are shown in FIG. 11 in computer system 70. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 11 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art. Where a conflict exists between the instant application and a reference provided herein, the instant application shall dominate.

1. A method comprising:
obtaining an onboarding request from a module of a training platform to migrate a machine learning model from the training platform to an inference platform, the onboarding request being obtained after a performance of a validation process by the training platform, the training platform facilitating training of the machine learning model using one or more training datasets, and the inference platform configured to implement the machine learning model for processing live data for determining responses to access requests for resources;
downloading an application package at the inference platform, the application package comprising the machine learning model;
receiving a statistically significant number of access requests for a plurality of resources;
determining, using the machine learning model, responses to the statistically significant number of access requests;
measuring a hardware performance of the inference platform for providing the responses;
performing an optimization process that varies a configuration value of each setting of a set of settings for the machine learning model to optimize the hardware performance of the machine learning model for a combination of the configuration values for the set of settings, the optimization process iteratively selecting the configuration value for each setting; and
implementing the machine learning model at the inference platform with the identified combination of the set of settings.

2. The method of claim 1, wherein the hardware performance of the inference platform for providing the responses estimates a data processing latency or a data processing throughput in the machine learning model determining responses to the statistically significant number of access requests.

3. The method of claim 1, further comprising:
determining that a network address for the module at the training platform is included on a whitelist for the inference platform, wherein the application package is downloaded at the inference platform responsive to the inference platform determining that the network address is included in the whitelist.

4. The method of claim 1, wherein implementing the machine learning model at the inference platform further comprises:
forwarding the live data comprising a series of access requests to the machine learning model, each access request requesting access to a resource; and
receiving, from the machine learning model for each access request, responses to the series of access requests, the responses providing an assessment of whether to grant access to the resource or deny access to the resource.

5. The method of claim 4, further comprising:
forwarding the responses to the series of access requests to a resource security system to grant or deny access to requested resources based on the responses to each of the series of access requests.

6. The method of claim 1, wherein the performance of the validation process at the training platform comprises:
providing, to the machine learning model at the training platform, a validation dataset for the machine learning model;
receiving, by the machine learning model at the training platform, responses to the validation dataset; and
comparing the responses to the validation dataset with known results for the validation dataset to derive an accuracy value, wherein the machine learning model is validated responsive to the accuracy value exceeding a threshold value.

7. The method of claim 1, wherein the application package is encrypted using a key common between the training platform and the inference platform, and wherein the inference platform decrypts the application package using the key.

8. The method of claim 1, wherein the training platform stores the machine learning model and a uniform resource locator (URL) for the application package at a data repository.

9. The method of claim 1, wherein performing the optimization process further comprises:
identify, for each of the set of settings, multiple configuration values; and
test each of the multiple configuration values to derive a result; and
update the combination of the set of settings to include a configuration value with a greatest result for each setting.

10. The method of claim 1, wherein performing the optimization process comprises, for each configuration value of each of the set of settings:
randomly selecting a first configuration value;
deriving a transactions per second (TPS) and latency result for the machine learning model using a combination of the set of settings including the first configuration value; and
responsive to determining that the TPS and latency result for the first configuration value exceeds a current result for the setting, updating the combination of the set of settings to include the first configuration value and updating the current result to include the TPS and latency result.

11. The method of claim 1, wherein the statistically significant number of access requests includes a threshold number of access requests provided to the machine learning model.

12. An inference platform configured to implement a machine learning model for processing live data for determining responses to access requests for resources, the inference platform comprising:
a processor; and
a computer-readable medium comprising instructions that, when executed by the processor, cause the processor to:
obtain an onboarding request from a module at a training platform to migrate the machine learning model from the training platform to the inference platform;
responsive to verifying the training platform, download an application package at the inference platform, the application package comprising the machine learning model;
receive a statistically significant number of access requests for a plurality of resources;
determine, using the machine learning model, responses to the statistically significant number of access requests;
measure a hardware performance of the inference platform for providing the responses;
perform an optimization process that varies a configuration value of each setting of a set of settings for the machine learning model to optimize the hardware performance of the machine learning model for a combination of the configuration values for the set of settings, the optimization process iteratively selecting the configuration value for each setting; and
implement the machine learning model at the inference platform with the identified combination of the set of settings.

13. The inference platform of claim 12, wherein the processor is further configured to:
validate the machine learning model responsive to determining that a network address for the module at the training platform is included on a whitelist for the inference platform.

14. The inference platform of claim 13, wherein the processor is further configured to:
provide, to the machine learning model at the training platform, a validation dataset for the machine learning model;
receive, by the machine learning model at the training platform, responses to the validation dataset; and
compare the responses to the validation dataset with known results for the validation dataset to derive an accuracy value, wherein the machine learning model is validated responsive to the accuracy value exceeding a threshold value.

15. The inference platform of claim 12, wherein the application package is encrypted using a key common between the training platform and the inference platform, and wherein the inference platform decrypts the application package using the key.

16. The inference platform of claim 12, wherein the processor is further configured to:
forward the live data comprising a series of access requests to the machine learning model, each access request requesting access to a resource; and
receive, from the machine learning model for each access request, responses to the series of access requests, the responses providing an assessment of whether to grant access to the resource or deny access to the resource.

17. The inference platform of claim 16, further comprising:
forwarding the responses to the series of access requests to a resource security system to grant or deny access to requested resources based on the responses to each of the series of access requests.

18. The inference platform of claim 12, wherein performing the optimization process further comprises:
identify, for each of the set of settings, multiple configuration values; and
test each of the multiple configuration values to derive a result; and
update the combination of the set of settings to include a configuration value with a greatest result for each setting.

19. The inference platform of claim 12, wherein performing the optimization process comprises, for each configuration value of each of the set of settings:
randomly selecting a first configuration value;
deriving a transactions per second (TPS) and latency result for the machine learning model using a combination of the set of settings including the first configuration value; and
responsive to determining that the TPS and latency result for the first configuration value exceeds a current result for the setting, updating the combination of the set of settings to include the first configuration value and updating the current result to include the TPS and latency result.

20. The inference platform of claim 12, wherein the training platform is configured to store the machine learning model and a uniform resource locator (URL) for the application package at a data repository.
